(19) United States
(12) Patent Application Publication
(10) Pub. No.: US 2015/0070207 A1
(43) Pub. Date: Mar. 12, 2015

(54) Method and Apparatus For Self Calibration of A Vehicle Radar System

(71) Applicant: Valeo Radar Systems, Inc., Hudson, NH (US)

(72) Inventors: Jeffrey Millar, Mont Vernon, NH (US); David Insana, Manchester, NH (US); Christian Sturm, Bietigheim-Bissingen (DE); Kevin Krupinski, Nashua, NH (US)

(21) Appl. No.: 14/020,053

(22) Filed: Sep. 6, 2013

(51) Int. Cl. G01S 13/00

(52) U.S. Cl. CPC G01S 13/006
USPC 342/174

(57) ABSTRACT

A radar sensor for use within a vehicle includes self calibration functionality for performing angle calibrations for the sensor when the sensor is mounted within the vehicle. In at least one embodiment, the radar sensor collects information on stationary infrastructure around the vehicle for use in calibration operations. The infrastructure information may be used to generate a Doppler Monopulse Image (DMI) or other graph for the sensor. A clutter ridge within the DMI or other graph may then be analyzed to determine calibration data for the sensor.

### FIELD

Subject matter disclosed herein relates generally to radio frequency (RF) systems and, more particularly, to vehicle radar systems for detecting objects in the vicinity of a vehicle.

### BACKGROUND

Radar sensors are increasingly being used within automobiles and other vehicles to provide information to drivers about target structures and vehicles in a vicinity of the automobiles. Radar sensors may be programmed to perform functions such as blind spot detection (BSD), lane change assist (LCA), cross traffic alert (CTA), and others to enhance safety and driver awareness on the road. To ensure accurate measurement of target information, radar sensors typically require some level of calibration to compensate for deviations from ideal operation. Often, calibration will be performed by the sensor manufacturer and the resulting calibration information will be stored within the sensor before the sensor in delivered to the auto manufacturer or the end user. It has been found, however, that in many cases these manufacturer calibrations are of reduced value when the sensor is eventually mounted within a vehicle. There is a need, therefore, for sensors that are capable of self calibration after they have been mounted within a vehicle.

### SUMMARY

In accordance with one aspect of the concepts, systems, circuits, and techniques described herein, a machine implemented method is provided for use in self calibration of a radar sensor mounted to a vehicle. More specifically, the method comprises: collecting information on stationary structures in a vicinity of the vehicle using the radar sensor as the vehicle travels past the stationary structures; generating a graph that plots normalized Doppler against monopulse phase difference or monopulse angle based on range/Doppler bins in the collected information, wherein normalized Doppler includes a ratio of radial velocity Vr to host velocity Vh, the graph having a clutter ridge comprising points representative of the stationary structures; and analyzing the clutter ridge of the graph to identify signal strength peaks associated with different normalized Doppler values and using the peaks to generate calibration values for the radar sensor.

In one embodiment, the method further comprises comparing the clutter ridge of the graph to an original phase curve associated with the radar sensor to determine a mounting angle of the sensor on the vehicle, the original phase curve including angle calibration information in sensor coordinates.

In one embodiment, comparing the clutter ridge to the original phase curve includes: calculating a correlation value for the clutter ridge and the original phase curve for each of a plurality of different test mounting angles; and determining a mounting angle of the sensor based on the correlation values.

In one embodiment, collecting information includes transmitting RF signals toward stationary structures, receiving return signals at a first and second receive antenna, and processing the return signals using a 2-dimensional DFT to form an array of range-Doppler bins for each receive antenna; and generating a graph includes plotting information to the graph for each of the range-Doppler bins in the array of range-Doppler bins, regardless of signal strength.

In one embodiment, generating a graph includes generating a Doppler Monopulse Image (DMI).

In one embodiment, the method further comprises analyzing the clutter ridge of the graph to determine variance values associated with identified peak values.

In one embodiment, the method further comprises determining whether to update a tracking filter based, at least in part, on measured variance values.

In one embodiment, calibration values of the radar sensor are stored within non-volatile storage within the sensor; the method further comprising: analyzing the collected information to determine quality metrics for the information; and determining whether to update stored calibration data based, at least in part, on the quality metrics.

In one embodiment, analyzing the clutter ridge of the graph to identify signal strength peaks associated with different normalized Doppler values and using the peaks to generate calibration values for the radar sensor includes: for a first normalized Doppler value associated with a first angle of arrival, scanning to find a first peak value in the clutter ridge; and for the first peak value, scanning to find a monopulse phase difference that corresponds to the first angle of arrival.

In accordance with another aspect of the concepts, systems, circuits, and techniques described herein, a radar sensor for use in a vehicle comprises: an RF transmitter to generate radio frequency (RF) transmit signals; a transmit antenna to transmit the RF transmit signals; first and second receive antennas to receive return signals representing reflections of the RF transmit signals from objects and structures within a region of interest about the vehicle; first and second analog-to-digital converters to digitize signals associated with the first and second receive antennas, respectively; and one or more digital processors to perform self-calibration for the radar sensor to calibrate the sensor for angle-of-arrival when it is mounted in a vehicle, wherein the one or more digital processors are configured to: collect information on stationary infrastructure about the vehicle while the vehicle is in motion for use in self-calibration; generate a graph that plots normalized Doppler against monopulse phase difference or monopulse angle based on range/Doppler bins in the collected information, wherein normalized Doppler includes a ratio of radial velocity Vr to host velocity Vh, the graph having a clutter ridge comprising points representative of the stationary infrastructure; analyze the clutter ridge of the graph to identify signal strength peak values associated with different monopulse phase differences; and generate calibration values for the radar sensor based on the peak values.

In one embodiment, the one or more digital processors are configured to analyze the clutter ridge of the graph to estimate a mounting angle of the sensor on the vehicle.

In one embodiment, the one or more digital processors are configured to analyze a zero Doppler line of the graph to estimate the mounting angle of the sensor on the vehicle.

In one embodiment, the one or more digital processors are configured to analyze the clutter ridge of the DMI to estimate the mounting angle of the sensor by performing a correlation operation between the clutter ridge and an original phase curve of the sensor at a number of different test mounting angles, the original phase curve including angle calibration information for the sensor in sensor coordinates.

In one embodiment, the one or more digital processors are configured to generate the graph using the collected information by plotting normalized Doppler versus monopulse phase difference or monopulse angle for a multitude of range/Doppler bins associated with the collected information, wherein normalized Doppler includes a ratio of radial velocity Vr to host velocity Vh.

In one embodiment, the one or more digital processors are configured to analyze the clutter ridge of the graph to determine variance values associated with the identified peak values.

In one embodiment, the one or more digital processors are configured to determine whether to update a tracking filter based, at least in part, on measured variance values.

In one embodiment, the radar sensor further comprises digital storage to store calibration values for the sensor, wherein the one or more digital processors are configured to: analyze the collected information to determine quality metrics for the information; and determine whether to update calibration data stored in the digital storage using new calibration values based, at least in part, on the quality metrics.

In one embodiment, the one or more digital processors are configured to update a stored calibration value when a newly generated calibration value has a higher quality metric value than the stored calibration value.

In one embodiment, the one or more digital processors are configured to generate the graph as a Doppler-Monopulse image (DMI).

### BRIEF DESCRIPTION OF THE DRAWINGS

The foregoing features may be more fully understood from the following description of the drawings in which:

FIG. 1a is a diagram illustrating an exemplary vehicle radar sensing scenario within which features described herein may be practiced;

FIG. 1b is a diagram illustrating another exemplary vehicle radar sensing scenario illustrating the collection of infrastructure data by a sensor associated with a moving vehicle in accordance with an embodiment;

FIG. 2 is a block diagram illustrating a processing arrangement within a vehicle radar sensor in accordance with an embodiment;

FIG. 3 is a block diagram illustrating an exemplary sensor architecture that may be configured for self-calibration in accordance with an embodiment;

FIG. 4 is a block diagram illustrating another exemplary sensor architecture that may be configured for self-calibration in accordance with an embodiment;

FIG. 5 is a waveform diagram illustrating an exemplary series of chirp signals that may be used as an RF transmit signal in accordance with an embodiment;

FIG. 6 is a diagram illustrating the processing of return signals associated with a first receive channel using a 2-dimensional FFT in accordance with an embodiment;

FIG. 7 is a diagram illustrating the theory behind a monopulse calculation;

FIG. 8 is a diagram illustrating a Doppler Monopulse Image (DMI) that may be generated using infrastructure readings of a sensor mounted on a vehicle in accordance with an embodiment;

FIG. 9 is the DMI of FIG. 8 showing the relationship between the clutter ridge of the DMI and an original phase curve after the original phase curve has been shifted by 25 degrees;

FIG. 10 is a plot illustrating the results of a correlation operation involving a clutter ridge of a DMI and an original phase curve in accordance with an embodiment;

FIG. 11 is a plot illustrating three versions of a monopulse phase curve for a radar sensor having two receive antennas separated by D=λ/2;

FIG. 12 is a plot illustrating three versions of a monopulse phase curve for a radar sensor having two receive antennas separated by D=3λ/2; and

FIGS. 13 and 14 are portions of a flowchart illustrating an exemplary method for operating a vehicle radar sensor in accordance with an embodiment.

### DETAILED DESCRIPTION

Techniques and systems described herein relate to vehicle radar systems and methods for providing self calibration in such systems. In various embodiments, techniques and structures are provided that allow a radar system associated with a vehicle to self-calibrate for angle of arrival using measurements associated with stationary infrastructure being passed by the vehicle while in motion. The infrastructure measurements may begin to be taken when, for example, a vehicle starts up and begins to move. The resulting calibration information may then be used to detect and track moving targets in a vicinity of the vehicle. The calibration techniques and systems described herein are capable of rapidly converging on calibration values that can be used to significantly increase the target angle measurement accuracy of the underlying sensor and its mounting environment. The speed of convergence of the calibration technique is due, in part, to the fact that all (or mostly all) of the collected infrastructure information is used during the calibration process, regardless of signal strength. For this reason, vast amounts of useable data can be collected in a relatively short time period. Although described below primarily in the context of automobiles, it should be appreciated that the radar systems and techniques described herein may be used in connection with a wide range of different vehicle types.

As described above, in some embodiments, a very large amount of data associated with surrounding infrastructure may be collected in a relatively short period of time for use in self-calibration. The collected information may include information that allows signal angle of arrival (AoA) to be estimated using two different techniques (e.g., monopulse AoA (as measured by phase difference between signals received by 2 or more antennas) and normalized Doppler speed (which depends on the angle of the target with respect to the host vehicles path)). While the monopulse angle information is sensitive to factors such as sensor mounting angle and other sensor based effects, the Doppler related angle information is relatively immune to these effects. Thus, the Doppler information may be used to gauge errors in the monopulse angle information. The angle calibration information may be derived by plotting the two different angle measures on a common graph.

The infrastructure related information collected by the sensor may be used to generate a Doppler Monopulse Image or DMI. Most of the information plotted on the DMI will be concentrated about a line known as a “clutter ridge” which contains information about the mounting angle of the sensor, the angle distortion of the sensor and its mounting environment, and the quality of the angle measurement process. For monopulse angle measurement, mounting angle causes a shift in the clutter ridge, antenna spacing error causes a twist, and multiple internal reflections cause angle ripples. For Doppler angle measurement, errors include vehicle speed estimate errors and reflections from objects that cannot be approximated as point targets. The clutter ridge may be compared to an original phase curve associated with the sensor (e.g., a curve measured during a manufacturing process or other sensor-oriented test procedure) to determine an actual mounting angle associated with the sensor on the vehicle. The clutter ridge may also be analyzed to determine AoA correction values that can be stored for use during subsequent target detection operations to increase the accuracy of AoA measurements made by the sensor. Other techniques for estimating mounting angle that do not depend on a factory phase curve may alternatively be used. These may include, for example, determining the location in monopulse angle terms where the clutter ridge crosses through zero Doppler. Techniques may also be used to avoid misestimating mounting angle due to the effects of localized distortion of the phase curve.

In some embodiments, the clutter ridge of the DMI may also be used to develop statistical information (e.g., peak data variances, quality statistics, etc.) that can be used to gauge, for example, the quality or reliability of the collected information. This quality and reliability information may then be used to, for example, determine whether or not to update previously stored calibration data and/or tracking information associated with a tracking filter using the data.

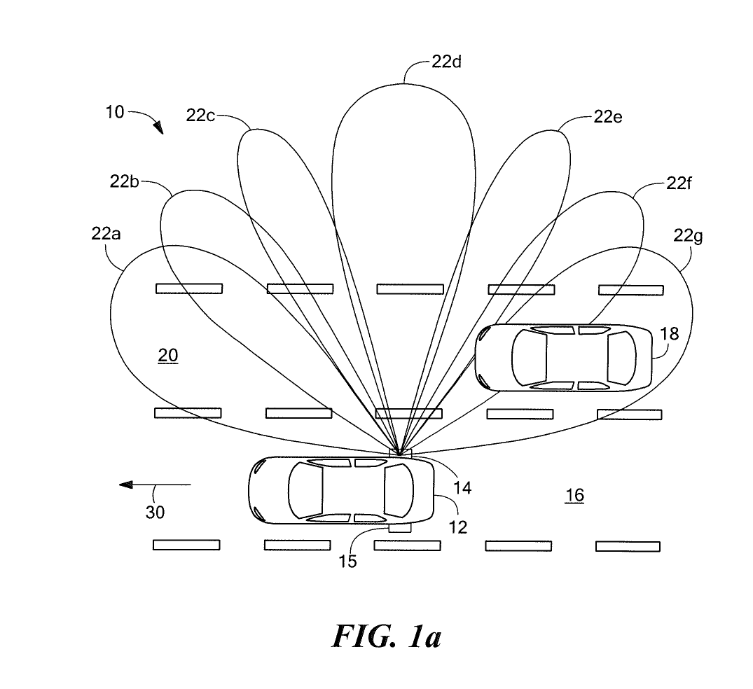

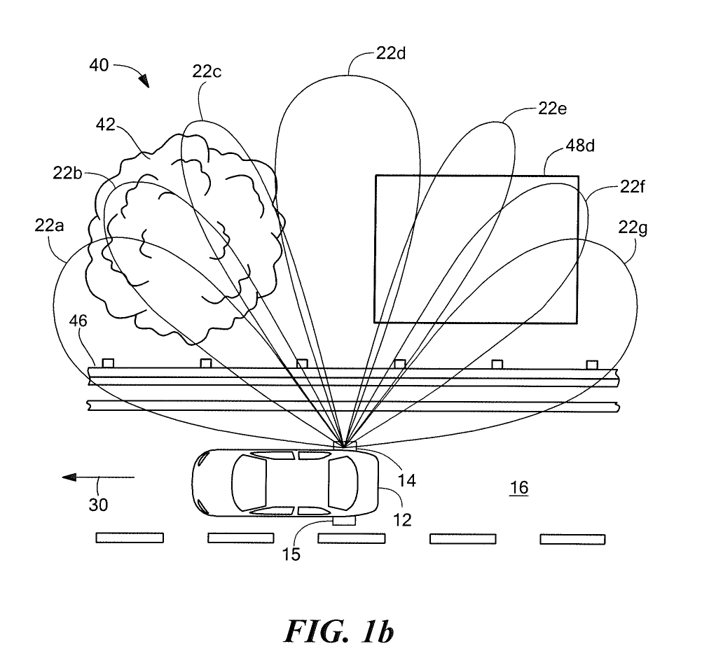

FIG. 1a is a diagram illustrating an exemplary vehicle radar sensing scenario 10 within which features described herein may be practiced. As shown, a first vehicle 12 is traveling within a lane 16 of a highway in a direction 30. A second vehicle 18 is traveling within an adjacent lane 20 of the highway in the same direction 30. The driver of the first vehicle 12 will want to be aware of the presence of the second vehicle 18 to, for example, avoid collision. However, the second vehicle 18 may be within a “blind spot” of the driver of the first vehicle 12 that hinders the driver's ability to see the second vehicle 18. To prevent potential problems, the first vehicle 12 may be equipped within one or more radar sensors 14, 15 mounted on the sides thereof that are capable of sensing and tracking other vehicles in the vicinity of the first vehicle 12. The sensors 14, 15 may be capable of measuring, for example, the position (e.g., angle) and speed of the other vehicles. The sensors 14, 15 may be coupled to other electronics within the first vehicle 12 that allow the sensors 14, 15 to, for example, warn the driver of the presence and location of other vehicles about the first vehicle 12 (e.g., a display, a speaker for an alert signal, etc.). A central controller may also be provided within the first vehicle 12 to coordinate the operation of multiple sensors within the vehicle in some embodiments.

The sensors 14, 15 may sense the presence of other vehicles and determine information about those vehicles using radio frequency (RF) signals. For example, one or more RF signals may be transmitted into a region of interest about the first vehicle 12 (e.g., a side region) by the sensor 14. If a target is present in this region, a portion of the transmitted RF signal may be reflected back by the target toward the sensor 14. The sensor 14 may then receive and analyze the return energy to determine information about the target vehicle. As used herein, the word “target” is used to describe objects of interest to the radar sensor for which data is desired (e.g., other moving vehicles, etc.). The word “infrastructure” is used to describe stationary objects and structures in the vicinity of a vehicle of interest (i.e., the vehicle carrying the radar sensor). The radar sensor may be able to distinguish infrastructure detections from moving vehicle detections based on Doppler shifts.

As described above, the sensors 14, 15 may transmit one or more RF signals toward a region of interest to detect nearby targets. As shown in FIG. 1a, in some embodiments, the sensor 14 may utilize multiple transmit beams 22a, 22b, 22c, 22d, 22e, 22f, 22g to cover a region of interest (e.g., the entire side region next to the first vehicle 12). Although illustrated with seven transmit beams, it should be appreciated that any number may be used in different embodiments. In some embodiments, the sensor 14 may use only a single transmit beam to cover a region of interest. When multiple transmit beams are used, the beams may be activated in sequence or in some other predefined manner to transmit the RF signals. Depending on the location of targets, if any, some transmit beams may result in target return energy being received at the sensor 14 and other beams may not. Target return energy will be analyzed by the sensor 14 to determine information about corresponding targets. Tracking units may also be provided within the sensors 14, 15 to track detected targets.

To develop accurate information about detected targets, specifically angle information, calibration is typically necessary to compensate for various effects of the sensor and its surroundings. During the sensor manufacturing process, or at a vehicle manufacturer location where the sensor will be integrated into a vehicle, some angle calibration may be performed for the sensor to generate calibrated angle values. However, these calibrated angle values will typically be determined within a test environment that is very much different from the environment within which the sensor will eventually be deployed. A number of different effects can cause this original phase information to be less accurate when the sensor is mounted in the vehicle. For example, the mounting angle of the sensor on the vehicle can affect the accuracy of angle measurements made by the sensor. This can be caused by, for example, a mounting bracket used to hold the sensor on the vehicle being skewed from a designed position. Certain distortion effects may also be present in the deployment region of the sensor that were not present during the original angle calibration. Such effects may include, for example, internal reflections between the sensor and the dielectric of the bumper, induced current in the vehicle body due to sidelobes of the radar, differences between the two or more antennas and their interconnecting lines, differences in receiver components in the different receive channels (e.g., mixers, amplifiers, filters, ADCs, etc.), and/or other effects.

In some aspects of the techniques and features described herein, self-calibration procedures are provided that are capable of performing angle calibration for a sensor that is already mounted within a final vehicle (as opposed to a test vehicle). These self-calibration procedures are capable of generating angle calibration values that take into account errors in mounting angle as well as other distortion effects that are unique to the mounting environment of the vehicle. The auto-calibration procedures may be used to coordinate a transformation from a sensor reference to a vehicle reference for measured values. When a sensor is deployed on a vehicle, calibrations based on the vehicle reference will lead to more accurate measurements being made by the radar.

As described above, in various embodiments, phase compensation values are developed for a sensor mounted on a vehicle by taking a large number of measurements of stationary infrastructure about a vehicle using the sensor, while the vehicle is in motion. The collected information may be processed and used to develop a Doppler Monopulse Image (DMI) from which angle calibration values may be derived. FIG. 1b is a diagram illustrating an exemplary vehicle radar sensing scenario 40 illustrating the collection of infrastructure data by a sensor 14 mounted on a moving vehicle 12 in accordance with an embodiment. In the illustrated scenario 40, the vehicle 12 is moving in a direction 30 within a lane of a highway. It should be appreciated, however, that the calibration procedures described herein may be performed anywhere that the vehicle 12 is able to achieve at least a minimal speed for at least a minimum time duration (e.g., less than 10 seconds in one embodiment). The infrastructure may include any stationary objects or structures located in an area around the moving vehicle 12. In the scenario 40 of FIG. 1b, for example, the infrastructure includes a tree 42, a building 44, and a guard rail 46. Other types of infrastructure may include, for example, signs, fire hydrants, parked vehicles, lampposts, parking meters, telephone poles, fences, walls, and/or other structures.

Information may be collected about the infrastructure by transmitting RF signals toward the infrastructure and then receiving and processing return information. In some embodiments, RF signals may be transmitted toward the infrastructure using multiple different transmit beams 22a, 22b, 22c, 22d, 22e, 22f, 22g. In other implementations, a single beam may be used. The collected information may be used to generate a DMI from which the calibration values may be derived. As will be described in greater detail, other useful information may also be extracted from the DMI for use within the sensor to improve overall sensor operation. This may include, for example, quality and variance information that may be used to, among other things, determine when updates should be made to a tracking unit, such as a Kalman filter. In some embodiments, the collection of infrastructure information may be initiated just after vehicle starts up, when the vehicle first reaches a particular speed. Once initiated, the collection of infrastructure information may be rapid. This is because, in some implementations, virtually all collected information is used during the calibration process, regardless of signal strength. Thus, a large amount of data may be rapidly collected.

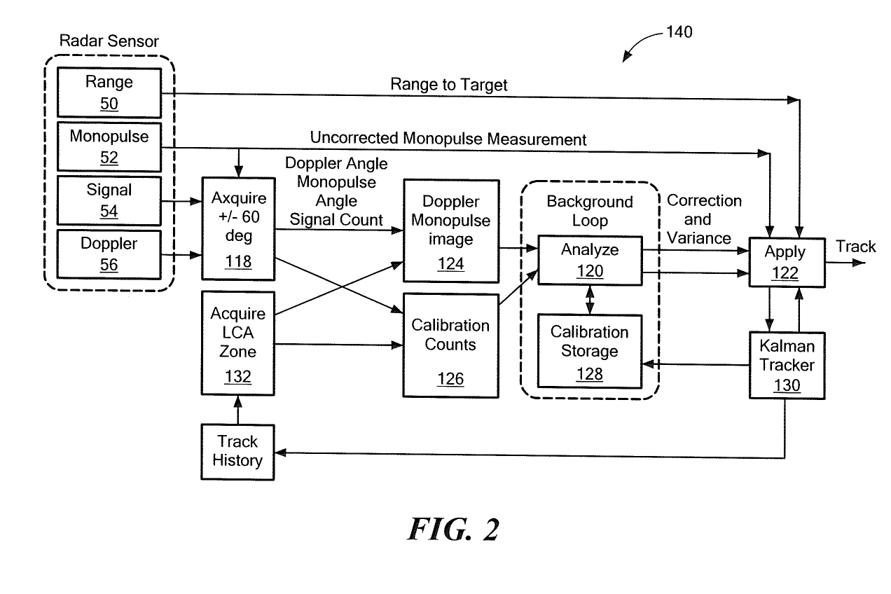

FIG. 2 is a block diagram illustrating a processing arrangement 140 within a vehicle radar sensor in accordance with an embodiment. The processing arrangement 140 includes a self-calibration function that is divided into three separate modules: an acquire module 118, and analyze module 120, and an apply module 122. During normal radar operation, the vehicle radar sensor may detect and track moving vehicles (i.e., targets) within one or more regions about a vehicle of interest. The sensor may make, for example, range measurements 50 and uncorrected monopulse measurements 52 for the targets and deliver the corresponding data to the apply module 122. The apply module 122 may then apply the calibration information developed during self-calibration to generate corrected target information. The corrected target information may then be delivered to a Kalman filter 130 or other tracking device for use in tracking the target(s). The tracking unit may track, for example, range, range rate, and azimuth angle of each detected target.

During a self-calibration mode, the acquire module 118 may be used to collect data corresponding to stationary infrastructure around the vehicle of interest. The data collection may take place when the vehicle of interest is moving within a particular speed range and may involve the receipt of radar return signals 54 in the sensor and the generation of Doppler information 56 using the return signals. The collection of data may be limited to a particular range of angles in some implementations. For example, in the illustrated embodiment, the collection of infrastructure data is limited to the range of ±60 degrees from broadside. Other ranges may alternatively be used (e.g., the full range of ±90 degrees from broadside, etc.). The collected infrastructure information may be used to develop a Doppler monopulse image (DMI) 124 for the infrastructure. The collected information may also be analyzed to determine calibration counts 126 for the data that can be used as a measure of signal quality and/or reliability (e.g., data points per second that pass quality test, age metrics associated with DMI, etc.).

In some implementations, the “acquire” stage of the self-calibration procedure may also include a separate collection of infrastructure information from a lane change assist (LCA) zone 132 toward the rear side of the vehicle of interest. This optional LCA zone information may also be used in developing the DMI 124 and the calibration counts 126.

The DMI and the calibration counts information may next be passed to the analyze module 120 for analysis. The analyze module 120 may perform various functions. For example, the analyze module 120 may analyze the DMI to determine an actual mounting angle of the radar sensor on the vehicle of interest. The sensor will typically be mounted on a bracket that is supposed to be set to a specific angle with respect to the vehicle. Differences from this desired mounting angle can generate errors within the target angle readings of the radar sensor. As will be described in greater detail, the analyze module 120 can estimate the actual mounting angle of the sensor based on the position of a clutter ridge within the DMI. The analyze module 120 may also be operative for measuring and reporting a phase curve ripple of the sensor based on the DMI. This phase curve ripple may represent a deviation of the phase curve from an ideal sine curve.

The analyze module 120 may be configured to measure a peak and variance for each of a plurality of angles of arrival. The peak and variance may be determined by, for example, scanning the clutter ridge of the DMI horizontally at a number of Vr/Vh angles to identify peaks and variances in terms of monopulse angle or monopulse phase difference. For example, for a particular Vr/Vh value, the analyze module 120 may scan to the right to identify a signal strength peak and then find a monopulse angle or monopulse phase difference on the x axis that corresponds to this peak. The analyze module 120 may also determine the variance in monopulse angle or monopulse phase difference for the peak. After peaks and variances have been identified, calibration lookup tables can be formed that are indexed by monopulse angle or monopulse phase difference. If there are multiple peaks within the clutter ridge for a particular angle, each peak may be recorded along with a corresponding variance value. The analyze module 120 may then store these tables within, for example, the calibration storage 128. The mounting angle information may also be stored within the calibration storage 128 in some implementations. The calibration storage 128 may comprise, for example, an EPROM or other form of non-volatile digital storage.

Other statistics that may be measured for the calibration values include quality statistics, stability statistics (to detect rain, blockages, etc.), reliability statistics, and/or others. In one possible approach, the calibration values stored in the calibration storage 128 may be updated when new calibration values are available that have a higher quality than those previously stored. In some implementations, the peak and variance information may be made available to the Kalman tracker 130 for use in determining whether the tracker should be updated using the latest information.

To generate calibration data using a DMI, in one approach, for each Vr/Vh row, the peak phase difference or monopulse angle may be found as well as the variance and other statistics and measures of quality of same. A lookup table may then be generated using the phase difference as an index to return a correction value and a variance value. This lookup table effectively contains the phase curve.

As described above, the apply module 122 is operative for applying the calibration information developed by the analyze module 120 to target measurements, to correct for angle. The apply module 122 may have access to, for example, the peak data, the variance data, the mounting angle data, and/or the statistics data generated by the analyze module 120. The apply module 122 may also be operative for using the clutter ridge statistics to manage the update process for the Kalman tracker 130. The apply module 122 may also be configured to use the clutter ridge statistics to control radar alert logic in some implementations. In some embodiments, the variance values may be used by the apply module 122 to improve Kalman tracking for, for example, blind spot detection (BSD), lane change assist (LCA), and cross traffic alert (CTA) functions.

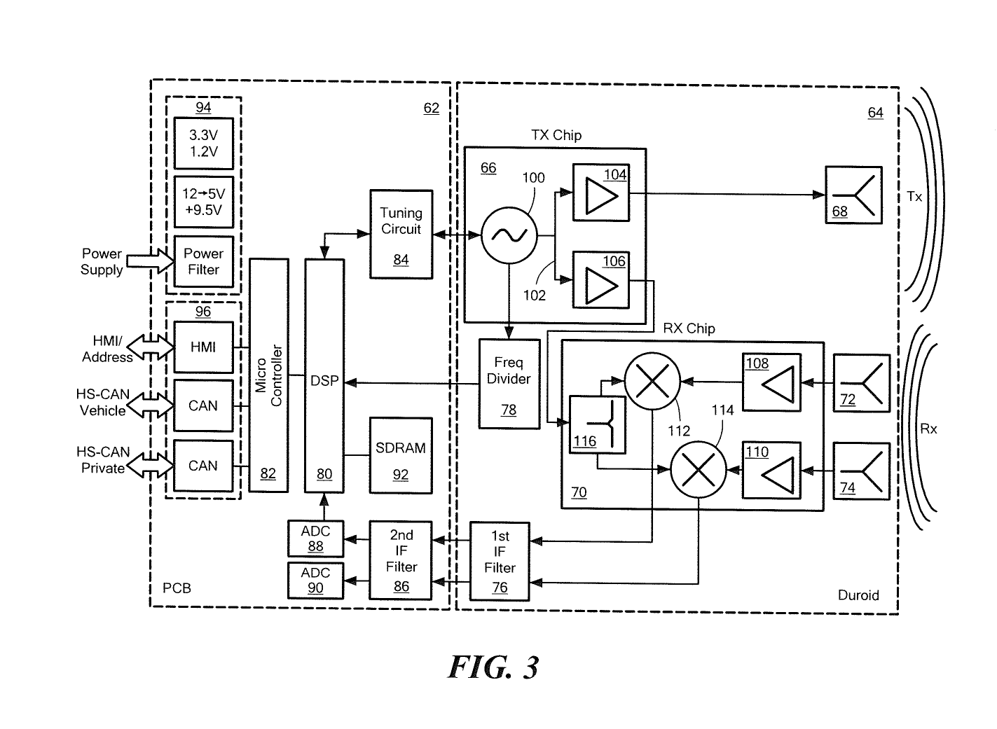

As described above, in various embodiments, monopulse techniques are used to measure the angle-of-arrival (AoA) of reflected signals at the receiver of a sensor. The calibration values that are developed may thus include phase values that correspond to the delta phase outputs associated with the monophase measurement of the sensor. FIG. 3 is a block diagram illustrating an exemplary sensor architecture 60 that may be configured for self-calibration in accordance with an embodiment. As shown, the sensor 60 may include a digital portion 62 and an RF portion 64. The RF portion 64 includes an RF transmitter 66, at least one transmit antenna 68, an RF receiver 70, first and second receive antennas 72, 74, and a first intermediate frequency (IF) filter 76. The digital portion 62 includes a digital signal processor (DSP) 80; a microcontroller 82; a frequency tuning circuit 84; a second IF filter 86; two analog-to-digital (A/D) converters 88, 90; a semiconductor memory 92; power circuitry 94, and one or more interfaces 96 for connecting to bus structures within the associated vehicle.

The microcontroller 82 is operative for controlling the overall operation of the sensor 60. The DSP 80 is operative for, among other things, processing digitized return signals received by the sensor 60 from a region of interest. The tuning circuit 84, under the control of the DSP 80 or another processor, may be used to facilitate generation of the transmit waveforms that will be transmitted from the sensor 60 during self-calibration and target sensing applications. As will be described in greater detail, the first and second A/D converters 88, 90 may be used to digitize signals received within two independent receive channels of the RF receiver 70. The digital samples output by the first and second A/D converters 88, 90 may be directed to the DSP 80.

In some embodiments, the DSP 80 may be configured to perform some or all of the actions involved in a self-calibration procedure in accordance with features described herein. In other embodiments, other types of digital processors and/or digital components may be used to perform some or all of these actions. These devices may include, for example, a general purpose microprocessor, a reduced instruction set computer (RISC), a complex instruction set computer (CISC), a field programmable gate array (FPGA), a programmable logic array (PLA), programmable array logic (PAL), an application specific integrated circuit (ASIC), a microcontroller, an embedded controller, a multi-core processor, a processor complex, an FFT unit, a DFT unit, and/or others, including combinations of the above. The semiconductor memory 92 may be used to, among other things, store programs for execution by the DSP 80 and/or other processors.

The RF transmitter 66 within the RF portion 64 of the sensor 60 may include a voltage controlled oscillator 100 to generate an RF transmit signal. In at least one embodiment, frequency modulated continuous wave (FMCW) signals are used as transmit signals during both self-calibration and target detection/tracking operations. The tuning circuit 84 may be used to generate the input control signals required by the VCO 100 to generate the FMCW signals (also known as chirp signals). The frequency divider 78 may be used as a feedback loop from the VCO 100 to the DSP 80 to adjust the frequency of the corresponding chirp signals to a desired range. The VCO 100 may be followed by a splitter 102 and a pair of amplifiers 104, 106. A first amplifier 104 may be operative for driving the transmit antenna 68 to transmit the RF transmit signal into the region of interest (e.g., the side region next to the vehicle). The single transmit antenna 68 should be capable of generating a transmit beam that covers the entire side region of interest. Any type of antenna may be used that is capable of covering this region including, for example, a patch, a dipole, an array, and/or others.

A second amplifier 106 within the transmitter 66 is operative for amplifying a copy of the transmit signal for use as a local oscillator (LO) signal for down converting received signals in the RF receiver 70. As shown in FIG. 3, the RF receiver 70 may include first and second low noise amplifiers (LNAs) 108, 110 that are coupled to amplify return signals received at the corresponding receive antennas 72, 74. First and second mixers 112, 114 may also be provided to down convert the received signals using the LO signal described above. A splitter 116 may be used to split the LO signal into two components for use by the first and second mixers 112, 114. The downconverted signals for the two receive channels are filtered by the first and second IF filters 76, 86 after which they are digitized in the first and second A/D converters 88, 90, respectively. The corresponding digital samples for each receive channel may then be delivered to the DSP 80 for further processing. The above-described processing may be performed for both self-calibration and target detection operations.

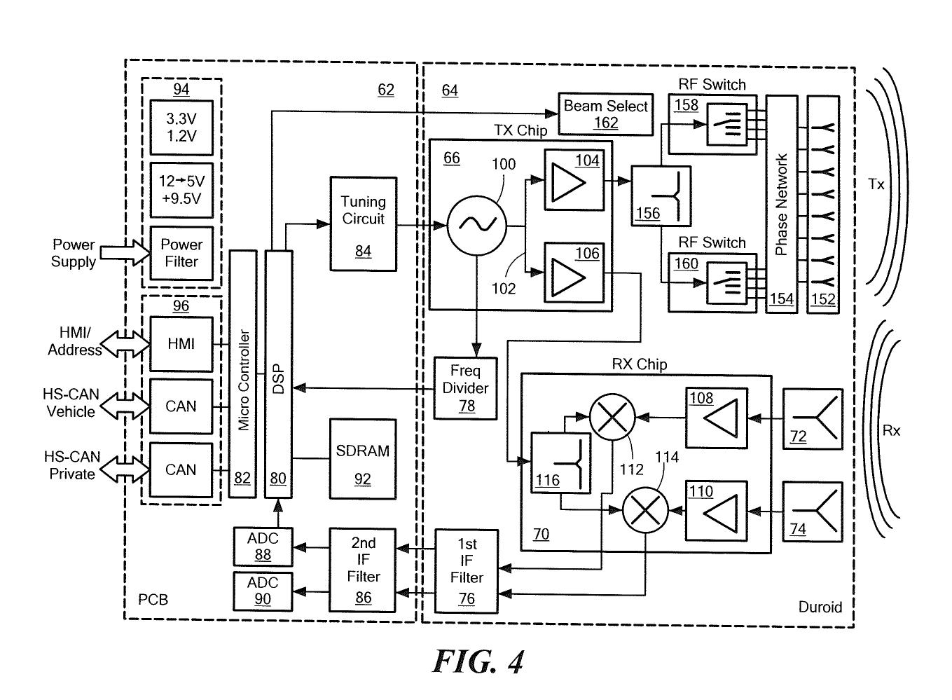

FIG. 4 is a block diagram illustrating another exemplary sensor architecture 150 that may be configured for self-calibration in accordance with an embodiment. The architecture 150 of FIG. 4 is similar to the architecture 60 of FIG. 3, except that a multiple transmit beam transmit antenna arrangement is used. As shown, the RF portion 64 of the sensor 150 includes a phased array antenna 152 that is fed by a Butler matrix 154. As is well known, a Butler matrix is a beam forming device that includes multiple input ports, where the beam that is created depends upon which input a transmit signal is applied to. As illustrated in FIG. 4, the output signal of the power amplifier 104 may be divided into two portions within a power divider 156. The two output signals of the power divider 156 may then be directed to first and second RF switches 158, 160 that are each connected to respective inputs of the Butler matrix 154. Beam select circuitry 162 may be coupled to the first and second RF switches 158, 160 for use in selecting the input(s) of the Butler matrix 154 that will receive the transmit signal at a particular point in time. The input that receives the transmit signal may be changed over time according to a predetermined sequence so that an entire side region of interest is covered by the transmit beams. The beam select circuitry 162 may be controlled by, for example, the DSP 80, the microcontroller 82, or some other processor/controller.

It should be appreciated that the sensor architectures 60, 150 of FIGS. 3 and 4 represent two possible architectures in which the self-calibration procedures described herein may be practiced. Many alternative architectures may be used. For example, other configurations for generating multiple transmit beams may be used in some embodiments. Also, different configurations for processing received RF signals before digitization may be used. Although the sensor architectures 60, 150 of FIGS. 3 and 4 are depicted with two receive antennas and corresponding receiver channels, it should be appreciated that additional receive antennas/channels may be used in some implementations.

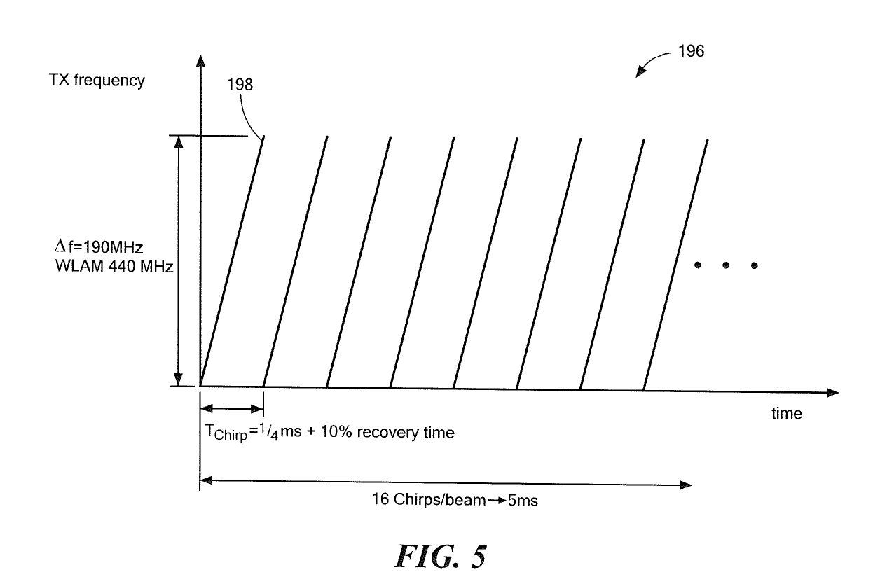

As described above, in some implementations, the RF transmit signals that are transmitted into a region of interest by the sensor are chirp signals. FIG. 5 is a waveform diagram illustrating an exemplary series of chirp signals 196 that may be used as an RF transmit signal during self calibration operations in accordance with an embodiment. In the illustrated waveform, each chirp pulse 198 has a linear frequency change of 190 MHz from start to finish. Each chirp 198 has a duration of around ¼ millisecond (ms) with a 10% recovery time before the next chirp. The transmit signal has a Wideband, Low Activity Mode (WLAM) bandwidth of 440 MHz. In a multi-beam transmitter implementation, a specific number of chirps (e.g., 16, etc.) may be transmitted per beam. The signals may be transmitted within successive beams every 5 ms in some implementations. During the self-calibration procedure, the process of collecting information from surrounding infrastructure may be repeated over and over again until enough information has been collected to form an adequate DMI image. Although specific parameters have been described above with respect to the transmit waveform, it should be appreciated that different transmit signal formats may be used in other implementations.

During a self-calibration procedure, after the return signals associated with the two receive channels have been digitized, the samples for each channel may be processed in a 2-dimensional discrete Fourier transform (DFT), one example of which is the 2-dimensional fast Fourier transform (FFT). Although any type of 2-dimensional DFT may be used, in the discussion that follows, the use of a 2-dimensional FFT will be assumed. For each receive channel, the 2-dimensional FFT will divide the received signal energy into a plurality of range/Doppler bins. As will be described in greater detail, the information within the various range/Doppler bins may be plotted to generate the DMI. In some embodiments, the 2-dimensional FFT may be implemented within a programmable or reconfigurable digital processing device (e.g., DSP 80 of FIGS. 3 and 4, etc.). In other embodiments, special FFT chips or processors may be used to provide the FFT processing.

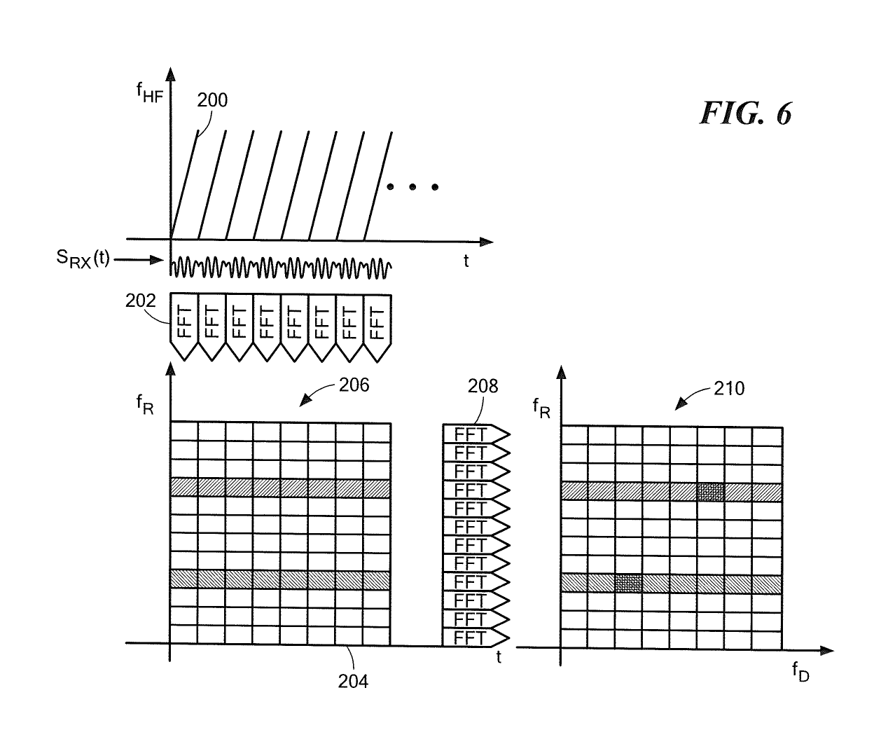

FIG. 6 is a diagram illustrating the processing of return signals associated with a first receive channel in a 2-dimensional FFT in accordance with an embodiment. As shown in FIG. 6, for each received chirp 200, a first FFT operation 202 is performed that divides the signal into a plurality of range bins 204. Processing of all the chirps results in a 2-dimensional array 206 of range bins over time. Each row of range bins in the two dimensional array 206 is then processed in a second FFT 208. The second FFT 208 converts the 2-dimensional array 206 of range bins over time into a 2-dimensional array of range/Doppler bins 210. Each range/Doppler bin in the array 210 corresponds to received energy having a particular Doppler shift that originated at a corresponding range within the region of interest. Each range/Doppler bin will have a corresponding magnitude (signal strength) and phase. There will be one 2-dimensional array 210 for each receive channel in the corresponding receiver. Although illustrated with 96 range-Doppler bins (i.e., 12 range bins 8 Doppler bins) in FIG. 6, it should be appreciated that the 2-dimensional array 210 may have significantly more bins in practice. For example, in one exemplary implementation, 80 range bins and 64 Doppler bins are used, resulting in 5120 total range/Doppler bins for each channel.

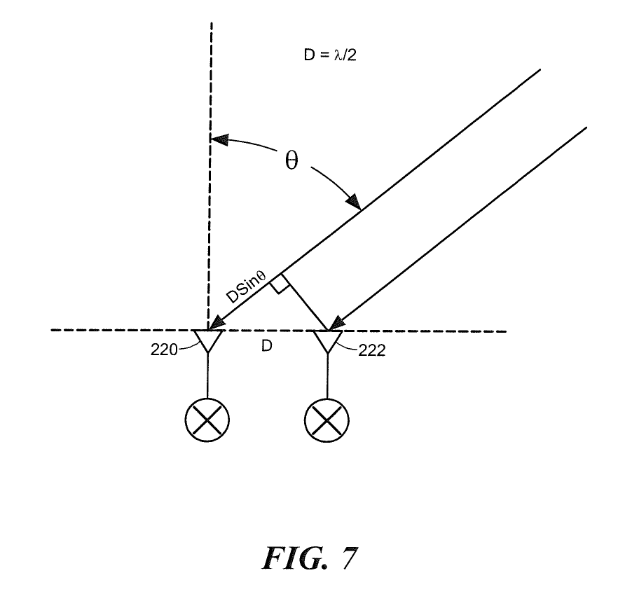

Monopulse is a radar technique that allows the angle-of-arrival of a signal to be estimated using the phase difference (or phase delta) of received energy at two separate receive antennas. FIG. 7 is a diagram illustrating the theory behind the monopulse calculation. As shown, signal energy is received from a target at an angle θ at two receive antennas 220, 222 that are separated by a distance D. Because the antennas are at different locations, the signal will travel an extra distance of Dₚ=D sin θ to reach antenna 220 than to reach antenna 222. This causes a phase difference between the two received signals. This phase difference may be measured and used to calculate the angle of arrival θ of the corresponding signal. That is, the phase difference may be used to find the value of Dₚ and the theoretical AoA may be calculated as θ=arcsin(Dₚ/D).

In a vehicle radar scenario, the angle-of-arrival may be defined as an angle between 0 and 180 degrees, with zero degrees corresponding to the forward direction of the vehicle and 180 degrees corresponding to the reverse direction of the vehicle. Using this definition of AoA, the “theoretical” monopulse angle-of-arrival of a signal may be calculated as follows, based on the measured monopulse phase difference in sensor coordinates. For a rising phase curve and D=λ/2:

A_{TM}=a cos((Δ_{CH}/−π)+1)×180/π

where A_{TM} is the angle of arrival and Δ_{CH} is the phase difference between channels. For the rising phase curve and D=3λ/2:

A_{TM}=a cos((Δ_{CH}/−3π)+1)×180/π.

For the falling phase curve and D=λ/2:

A_{TM}=a cos((Δ_{CH}/π)+1)×180/π.

For the falling phase curve and D=3λ/2:

A_{TM}=a cos((Δ_{CH}/3π)+1)×180/π.

Similar equations may be derived for other antenna spacings.

As described above, using a series of returned chirp signals, a 2-dimensional array of range/Doppler bins 210 may be generated for each receive channel in the receiver. For each range/Doppler bin, a monopulse angle-of-arrival may be calculated based on a phase difference between corresponding bins in the two arrays. The monopulse angle may be calculated using the theoretical monopulse AoA relationships above. As will be described in greater detail, these monopulse AoA values may be used to generate the DMI image. In an alternative approach, the raw phase difference information may be used to generate the DMI (or a modified version of the DMI).

The monopulse AoA (or phase difference) represents one measure for angle-of-arrival of signals at a sensor within a vehicle. Another measure of angle that can be used with stationary infrastructure is related to the normalized Doppler reading of the received energy when read from a sensor on a moving vehicle. The normalized Doppler may be defined as Vr/Vh, where Vr is the range rate of an infrastructure object based on its sensed Doppler frequency read from the moving vehicle and Vh is the forward velocity of the host vehicle. When a stationary object is in front of a moving vehicle on the side of the road, for example, the object will appear to be moving toward the sensor at the speed of the vehicle based on the Doppler reading. Thus, the normalized Doppler value will be equal to −1 (with the direction away from the sensor being defined as the positive direction). When a stationary object is behind the moving vehicle on the side of the road, the object will appear to be moving away from the sensor at the speed of the vehicle. Thus, the normalized Doppler value will be equal to +1. When a stationary object is directly to the right of the moving vehicle when a reading is taken, the object will appear to be stationary (i.e., speed=0) based on the Doppler reading. Thus, the normalized Doppler will be zero. At other angles, the normalized Doppler will range between ±1 in a known manner. Thus, the normalized Doppler reading may be used as a measure of the angle of arrival with respect to the moving vehicle. In addition, this angle measurement will not be affected by either the mounting angle of the sensor on the vehicle or other effects related to the sensor and its environment. Therefore, this measure is useful in determining correction values for AoA measurements made using monopulse. The speed of the vehicle can be determined from, for example, the speedometer of the vehicle or a GPS receiver within the vehicle. Each range/Doppler bin within an array of bins (e.g., array 210 of FIG. 6) has a corresponding Doppler speed. Thus, for each bin, a normalized Doppler reading can be calculated.

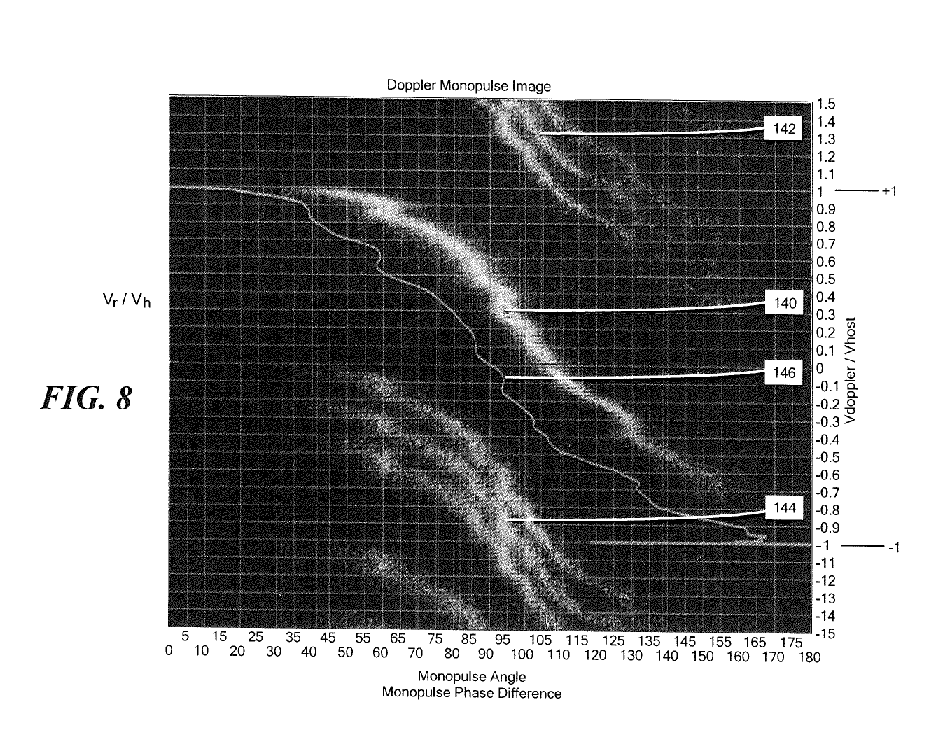

FIG. 8 is a diagram illustrating a Doppler Monopulse Image (DMI) that may be generated using infrastructure readings of a sensor associated with a vehicle in accordance with an embodiment. The vehicle will be moving with respect to the infrastructure when the readings are taken. As shown, the x-axis of the DMI represents monopulse angle and the y-axis of the DMI represents the normalized Doppler reading (Vr/Vh). In an alternative approach, the x-axis of the DMI will represent raw monopulse phase difference information (i.e., the difference between the phases of the receive signals within the two receive channels). As described above, for each range/Doppler bin in a two dimensional array, both a monopulse angle (or phase difference) and a normalized Doppler value may be generated. The phase difference can be generated for a range/Doppler bin by calculating a difference between the phase values for that bin in the two corresponding 2-dimensional FFT arrays. The monopulse angle (if calculated) may be determined by processing the measured phase difference between the phases of bins associated with two receive channels according to the theoretical monopulse relationship. The normalized Doppler may be calculated based on the Doppler frequency of the bin and the known speed of the host vehicle. During data collection, data associated with all range/Doppler bins of received signals may be plotted on the DMI (or some other graph). In this regard, RF transmit signals may be continually transmitted to facilitate the data collection. If multiple transmit beams are used, signals may be transmitted within the different beams in some predefined order which can be repeated at a specific rate. If a single transmit beam is used, transmit signals may be continually transmitted using the single beam.

As described above, in some embodiments, the DMI (or other graph) may be plotted as the normalized Doppler versus the monopulse angle, with the monopulse angle calculated using the theoretical monopulse relationship. In other embodiments, the normalized Doppler may be plotted directly against the monopulse phase difference, rather than the calculated monopulse angle. This approach eliminates the need to calculate monopulse angles using the theoretical relationship.

As points are added to the DMI, a clutter ridge 140 eventually develops within the image that represents the infrastructure passed by the vehicle. Each range-Doppler bin in the 2 dimensional FFT may be mapped into a corresponding pixel of the DMI. As shown in FIG. 8, the clutter ridge 140 occurs between normalized Doppler values of +1 and −1. The DMI may also include regions of Doppler Nyquist aliasing 142, 144. Although illustrated in black and white in FIG. 8, the DMI may use color or intensity to indicate variations in signal strength between different pixels. The signal strength of the different pixels may represent an average signal strength, averaged over a number of measurements. For example, in one possible approach, each new value will get blended into the DMI using an HR algorithm. This may include, for example, adding 1% of the new value in a pixel location to 99% of the previous value.

In general, each pixel of the DMI holds the signal power of the infrastructure object that returned that particular Doppler, monopulse, and strength. Strong signals have less noise and provide a better measurement of Doppler and monopulse. Weak signals or receiver noise generally have a random Doppler and monopulse. Averaging the signal strengths using an IIR technique improves the signal to noise ratio and allows the clutter ridge to build up over time. The more averaging allowed, the clearer the clutter ridge shape becomes, but the longer it takes to reach nearly final value. Long averaging times also increase the amount of time that less accurate data, such as data resulting from distorting effects of moving targets and/or rain, will be maintained. In some embodiments, the time constant of the IR will be balanced between accuracy, response time, and the ability to forget bad data.

In addition to the measured infrastructure data plotted on the DMI, an original monopulse calibration phase curve associated with the sensor may also be plotted in some embodiments. The original phase curve may have been generated during a calibration procedure before the sensor was permanently installed in the vehicle of interest. The original phase curve may be generated by, for example, measuring a 2-channel phase difference in a sensor as an ARC arm coupled to the sensor is moved through a series of angles from 0 to 180 degrees (in sensor coordinates). The phase difference values of the original phase curve may be mapped onto the DMI by using the above-described theoretical relationships (or similar relationships) to determine the angles for the x-axis of the DMI. The corresponding y-axis points may be calculated using the following shifted theoretical cosine relationship:

Theoretical Normalized Doppler=cos((0:180+cc)π)/180)

where cc represents the mounting angle.

The original phase curve may be used to estimate an actual mounting angle of the sensor on the vehicle by comparing the original phase curve to the clutter ridge of the DMI. In FIG. 8, the original phase curve is shown as curve 146 for an assumed mounting angle of 0 degrees. In one possible approach to determining the actual mounting angle, a correlation operation may be performed between the clutter ridge 140 and the original phase curve 146 at a number of different test mounting angles. The test mounting angle may be varied by changing the value of cc in the Theoretical Normalized Doppler equation above. In at least one embodiment, the correlation operation may be performed by calculating a sum of the pixel energy in the DMI for all pixels that intersect the original phase curve. This may be repeated for each of a plurality of different test mounting angles. The test mounting angle that generates the highest sum (i.e., the highest correlation) may then be taken as the actual mounting angle. It should be appreciated that, in some implementations, techniques other than correlation with an original phase curve may be used to determine an actual mounting angle of the sensor.

In some implementations, a correlation process to find an actual mounting angle may be performed in two phases, a coarse phase and a fine phase. During the coarse phase, a higher separation between test mounting angles may be used. During the fine phase, a finer separation between test mounting angles may be used, centered around the test mounting angle found during the coarse phase. For example, during the coarse phase, mounting angles from 0 to 50 degrees may be considered in 1 degree increments. This may result in a coarse mounting angle (CMA). The fine phase may then use test angles ranging from (CMA −0.5 degrees) to (CMA+0.5 degrees), in 0.02 degree increments. The final result of such a process may be a course mounting angle and a fine mounting angle. In some implementations, the same number of test mounting angles (e.g., 50) is used during the coarse and fine phases, although this is not required.

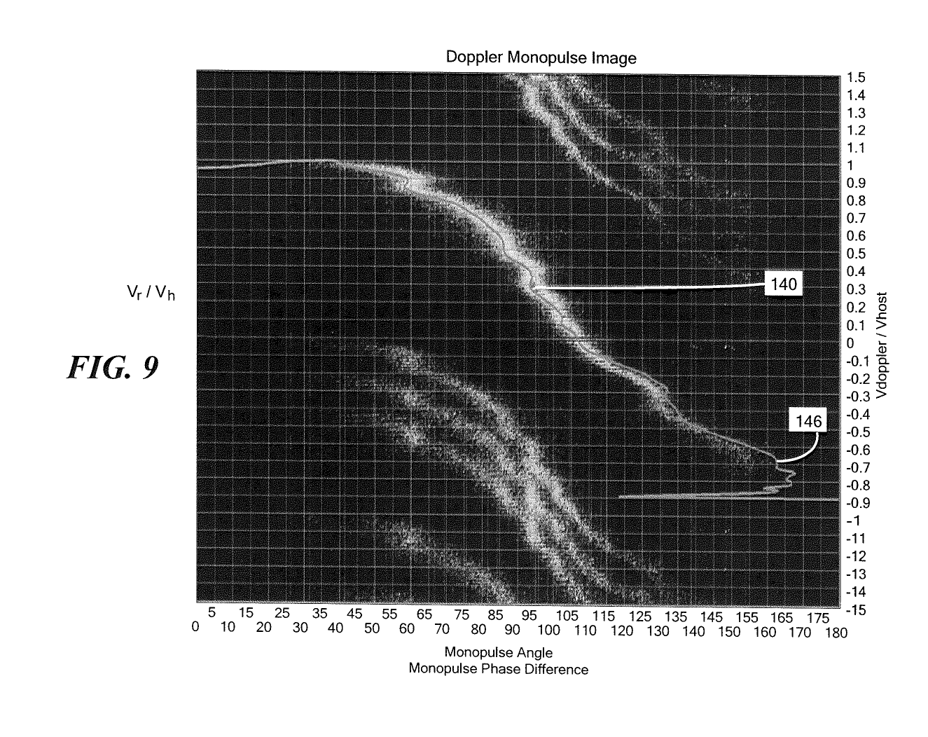

FIG. 9 is a diagram illustrating the DMI of FIG. 8 with the original phase curve 146 plotted using a test mounting angle of 25 degrees. As shown, the original phase curve 146 and the clutter ridge 140 are in substantial alignment. Thus, 25 degrees may represent (or be close to) the actual mounting angle of the sensor.

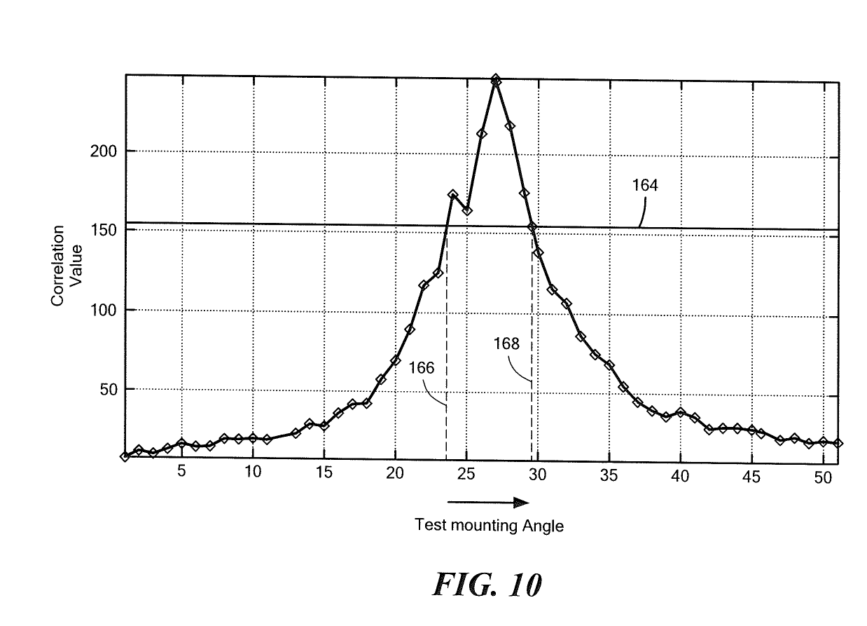

FIG. 10 is a plot illustrating correlation results from a coarse phase of a correlation procedure. In this implementation, a threshold value 164 is determined based on a mean value of maximum and minimum correlation outputs. The threshold value 164 is then used to identify the first and last test mounting angles 166, 168 where the correlation value is above the threshold 164 (corresponding to test mounting angle indices 24 and 29, respectively, in FIG. 10). The rounded average of the identified indices (27 in this example) may then be taken as the CMA that is passed to the fine phase of the correlation procedure. As will be appreciated, other techniques for determining the coarse mounting angle may alternatively be used.

In some prior vehicle radars, sensor mounting angle was a key value in the operation of the radar. When self calibration is utilized, however, mounting angle may simply be used as a metric for diagnostics purposes. The calibration lookup table generated by analysis of the clutter ridge may directly provide a calibration value for each measured phase difference or monopulse angle without the need for a mounting angle in the overall system of calibration.

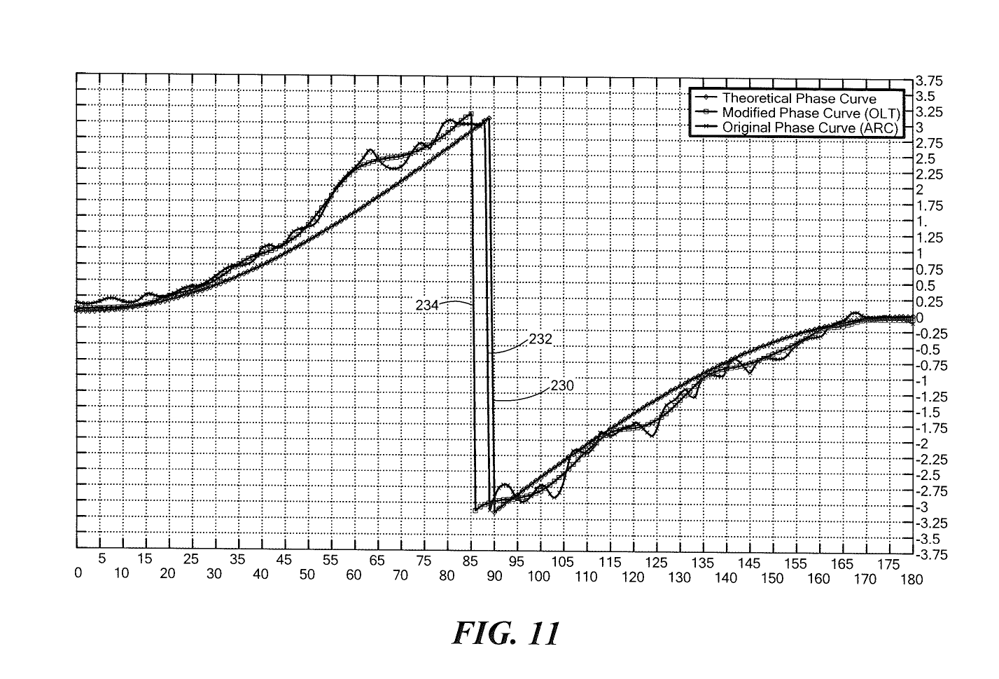

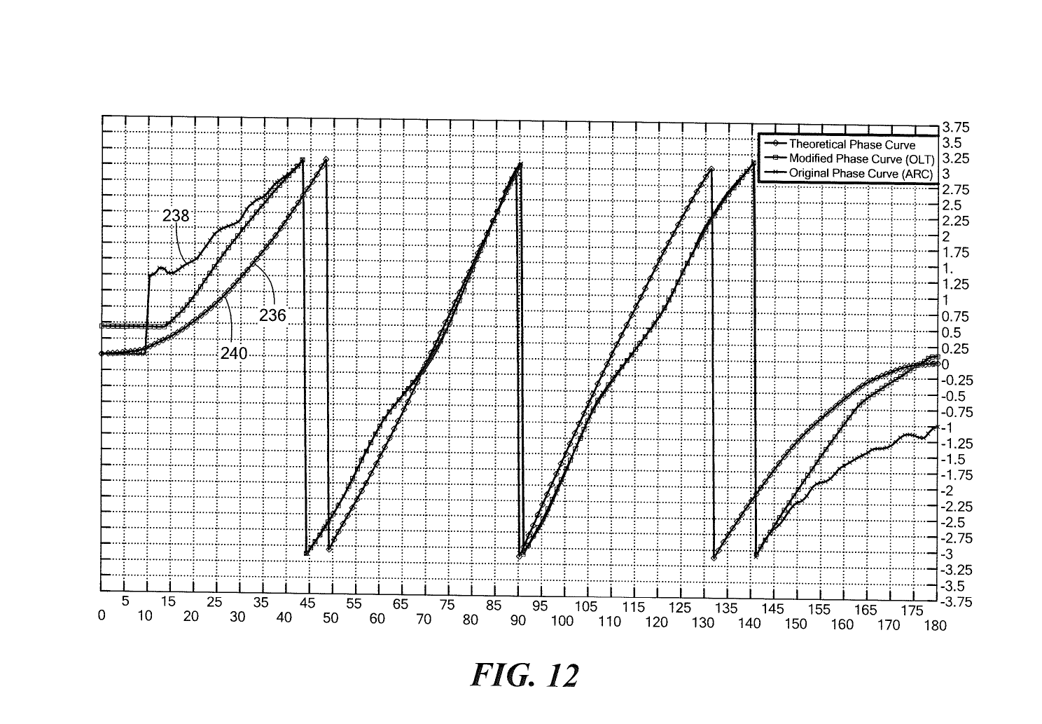

FIG. 11 is a plot illustrating three versions of a monopulse phase curve for a radar sensor having two receive antennas separated by D=λ/2. As shown, the plot includes a first curve 230 representative of the theoretical phase curve, a second curve 232 representative of the original phase curve, and a third curve 234 representative of a modified (corrected) phase curve. Similarly, FIG. 12 is a plot illustrating three versions of a monopulse phase curve for a radar sensor having two receive antennas separated by D=3λ/2. The plot includes a first curve 236 representative of the theoretical phase curve, a second curve 238 representative of the original phase curve, and a third curve 240 representative of the modified phase curve. Similar curves may result for other receive antenna spacings.

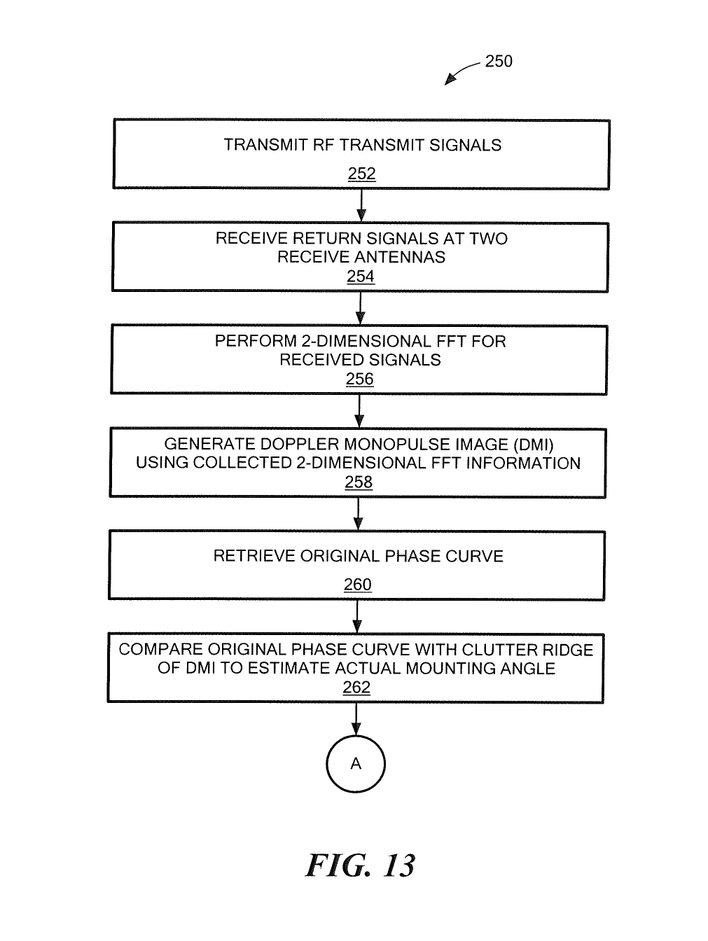

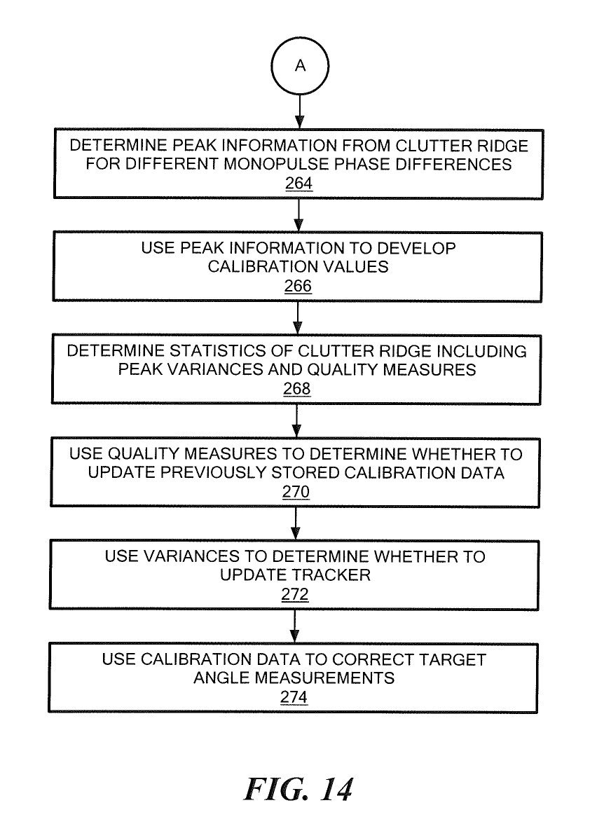

FIGS. 13 and 14 are portions of a flow diagram showing an exemplary method 250 for operating a vehicle radar sensor in accordance with an embodiment. The method 250 may be used with sensors having the architectures of FIGS. 3 and 4 and in other radar sensors and systems.

The rectangular elements in the flow diagram (typified by element 252 in FIG. 13) are herein denoted “processing blocks” and may represent computer software instructions or groups of instructions. It should be noted that the flow diagram of FIGS. 13 and 14 represents one exemplary embodiment of a design described herein and variations in such a diagram, which generally follow the process outlined, are considered to be within the scope of the concepts, systems, and techniques described and claimed herein.

Alternatively, the processing blocks may represent operations performed by functionally equivalent circuits such as, for example, a digital signal processor circuit, an application specific integrated circuit (ASIC), a field programmable gate array (FPGA), or another analog or digital circuit. Some processing blocks may be manually performed while other processing blocks may be performed by a processor or other circuit. The flow diagram does not depict the syntax of any particular programming language. Rather, the flow diagram illustrates the functional information one of ordinary skill in the art might need to fabricate circuits and/or to generate computer software or configuration information for reconfigurable hardware to perform the processing of a particular system. It should be noted that many routine program elements, such as initialization of loops and variables and the use of temporary variables, may not be shown in the figures. It will be appreciated by those of ordinary skill in the art that unless otherwise indicated herein, the particular sequence described is illustrative only and can be varied without departing from the spirit of the concepts described and/or claimed herein. Thus, unless otherwise stated, the processes described below are unordered meaning that, when possible, the sequences shown in FIGS. 13 and 14 can be performed in any convenient or desirable order.

Turning now to FIG. 13, RF transmit signals may be transmitted into a region of interest about a vehicle that includes stationary infrastructure (block 252). The RF transmit signals may be transmitted when, for example, the vehicle is moving at a speed within a predetermined range (e.g., greater than 10 kph in one implementation). The RF transmit signals may include, for example, a series of chirp signals or any other type of signal that is capable of acquiring relevant infrastructure information from the region of interest. Return signals are received at two (or more) receive antennas of the sensor (block 254). The return signals result from reflection of the transmitted RF signals from the stationary infrastructure within the region of interest.

A 2-dimensional FFT is performed for each of two (or more) receive channels (block 256). The received signals may be downconverted, filtered, and digitized before the 2-dimensional FFT is applied. Digital downconversion may be used in some implementations. Information associated with the 2-dimensional FFT (i.e., range-Doppler bin information) is then used to develop a Doppler Monopulse Image (DMI) (block 258). The phases of the range-Doppler bins of the 2-dimensional FFTs may be used to generate information for the x-axis of the DMI (e.g., phase difference values or monopulse angle values). The Doppler values of the bins, and knowledge of the speed of the vehicle of interest, may be used to generate normalized Doppler values (Vr/Vh) for the y-axis of the DMI. Averaging may be used to average the signal strengths of points plotted on the DMI. An IIR filter or the like can be used to perform the averaging. The above-described process of transmitting RF signals, receiving return signals, performing a 2-dimensional FFT, and generating (or updating) the DMI may be performed repeatedly before a useable DMI is formed. In some embodiments, this process may run continuously in the background during sensor operation to update the DMI with IIR filtered information.

In some implementations, an original phase curve may next be retrieved from storage (block 260). The original phase curve may be compared to a clutter ridge of the DMI to estimate an actual mounting angle of the sensor on the vehicle (block 262). The mounting angle information may be stored within non-volatile storage in the sensor for later use as a diagnostic measure. Any type of comparison may be performed that is capable of accurately estimating the actual mounting angle based on the original phase curve and the clutter ridge. In at least one embodiment, a correlation procedure is used. In some embodiments, the mounting angle is determined from the DMI without using an original calibration phase curve. For example, in at least one embodiment, the mounting angle may be estimated by first identifying the zero Doppler line within the DMI (e.g., Vr/Vh=0). A peak value in phase difference may then be determined for this line. This line will line up with energy that is directly perpendicular to the motion of the vehicle and can be used as a quick measure of mounting angle. These embodiments dispense with the need to perform laborious factory calibrations for the sensors. In some implementations, a mounting angle determination is not made.

Referring now to FIG. 14, the clutter ridge of the DMI may now be analyzed to identify peak information for different Vr/Vh values with corresponding monopulse phase differences or angles of arrival (block 264). The peak information may next be used to generate calibration values for the sensor (block 266). The angle calibration data may be stored within non-volatile storage of the sensor. Statistics of the clutter ridge of the DMI may also be determined (block 268). The statistics may include, for example, peak variance information, signal quality statistics (e.g., signal strength, SNR, etc.), and/or stability statistics. The quality statistics may be used to determine whether or not to update previously stored angle calibration data with the newly generated data (e.g., update if the quality of the new data is better than the quality of the previous data, etc.) (block 270). The variances may be used to determine whether or not the tracker (e.g., a Kalman filter, etc.) should be updated based on the new information (block 272). In at least one embodiment, the tracking filter is always updated and the variance information is instead used to control the strength of the update per the operation of the filter. The stored calibration data may subsequently be used to correct target angle measurements during, for example, target detection and tracking operations (block 274).

As used herein, the phrases “generating a graph,” “generating a DMI,” and the like may include generating a data structure that includes plotted information. That is, these phrases are not limited to the generation of a viewable graph.

Having described exemplary embodiments of the invention, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

What is claimed is:

1. A machine implemented method for use in self calibration of a radar sensor mounted to a vehicle, the method comprising:
collecting information on stationary structures in a vicinity of the vehicle using the radar sensor as the vehicle travels past the stationary structures;
generating a graph that plots normalized Doppler against monopulse phase difference or monopulse angle based on range/Doppler bins in the collected information, wherein normalized Doppler includes a ratio of radial velocity Vr to host velocity Vh, the graph having a clutter ridge comprising points representative of the stationary structures; and
analyzing the clutter ridge of the graph to identify signal strength peaks associated with different normalized Doppler values and using the peaks to generate calibration values for the radar sensor.

2. The method of claim 1, further comprising:
comparing the clutter ridge of the graph to an original phase curve associated with the radar sensor to determine a mounting angle of the sensor on the vehicle, the original phase curve including angle calibration information in sensor coordinates.

3. The method of claim 2, wherein comparing the clutter ridge to the original phase curve includes:
calculating a correlation value for the clutter ridge and the original phase curve for each of a plurality of different test mounting angles; and
determining a mounting angle of the sensor based on the correlation values.

4. The method of claim 1, wherein:
collecting information includes transmitting RF signals toward stationary structures, receiving return signals at a first and second receive antenna, and processing the return signals using a 2-dimensional DFT to form an array of range-Doppler bins for each receive antenna; and
generating a graph includes plotting information to the graph for each of the range-Doppler bins in the array of range-Doppler bins, regardless of signal strength.

5. The method of claim 4, wherein:
generating a graph includes generating a Doppler Monopulse Image (DMI).

6. The method of claim 1, further comprising:
analyzing the clutter ridge of the graph to determine variance values associated with identified peak values.

7. The method of claim 6, further comprising:
determining whether to update a tracking filter based, at least in part, on measured variance values.

8. The method of claim 1, wherein:
calibration values of the radar sensor are stored within non-volatile storage within the sensor,
the method further comprising:
analyzing the collected information to determine quality metrics for the information; and
determining whether to update stored calibration data based, at least in part, on the quality metrics.

9. The method of claim 1, wherein:
analyzing the clutter ridge of the graph to identify signal strength peaks associated with different normalized Doppler values and using the peaks to generate calibration values for the radar sensor includes:
for a first normalized Doppler value associated with a first angle of arrival, scanning to find a first peak value in the clutter ridge; and
for the first peak value, scanning to find a monopulse phase difference that corresponds to the first angle of arrival.

10. A radar sensor for use in a vehicle, the radar sensor comprising:
an RF transmitter to generate radio frequency (RF) transmit signals;
a transmit antenna to transmit the RF transmit signals;
first and second receive antennas to receive return signals representing reflections of the RF transmit signals from objects and structures within a region of interest about the vehicle;
first and second analog-to-digital converters to digitize signals associated with the first and second receive antennas, respectively; and
one or more digital processors to perform self-calibration for the radar sensor to calibrate the sensor for angle-of-arrival when it is mounted in a vehicle, wherein the one or more digital processors are configured to:
collect information on stationary infrastructure about the vehicle while the vehicle is in motion for use in self-calibration;
generate a graph that plots normalized Doppler against monopulse phase difference or monopulse angle based on range/Doppler bins in the collected information, wherein normalized Doppler includes a ratio of radial velocity Vr to host velocity Vh, the graph having a clutter ridge comprising points representative of the stationary infrastructure;
analyze the clutter ridge of the graph to identify signal strength peak values associated with different monopulse phase differences; and
generate calibration values for the radar sensor based on the peak values.

11. The radar sensor of claim 10, wherein:
the one or more digital processors are configured to analyze the clutter ridge of the graph to estimate a mounting angle of the sensor on the vehicle.

12. The radar sensor of claim 11, wherein:
the one or more digital processors are configured to analyze a zero Doppler line of the graph to estimate the mounting angle of the sensor on the vehicle.

13. The radar sensor of claim 11, wherein:
the one or more digital processors are configured to analyze the clutter ridge of the DMI to estimate the mounting angle of the sensor by performing a correlation operation between the clutter ridge and an original phase curve of the sensor at a number of different test mounting angles, the original phase curve including angle calibration information for the sensor in sensor coordinates.

14. The radar sensor of claim 10, wherein:
the one or more digital processors are configured to generate the graph using the collected information by plotting normalized Doppler versus monopulse phase difference or monopulse angle for a multitude of range/Doppler bins associated with the collected information, wherein normalized Doppler includes a ratio of radial velocity Vr to host velocity Vh.

15. The radar sensor of claim 10, wherein:
the one or more digital processors are configured to analyze the clutter ridge of the graph to determine variance values associated with the identified peak values.

16. The radar sensor of claim 15, wherein:
the one or more digital processors are configured to determine whether to update a tracking filter based, at least in part, on measured variance values.

17. The radar sensor of claim 10, further comprising:
digital storage to store calibration values for the sensor,
wherein the one or more digital processors are configured to:
analyze the collected information to determine quality metrics for the information; and
determine whether to update calibration data stored in the digital storage using new calibration values based, at least in part, on the quality metrics.

18. The radar sensor of claim 17, wherein:
the one or more digital processors are configured to update a stored calibration value when a newly generated calibration value has a higher quality metric value than the stored calibration value.

19. The radar sensor of claim 10, wherein:
the one or more digital processors are configured to generate the graph as a Doppler-Monopulse image (DMI).
